(19) United States
(12) Patent Application Publication
(10) Pub. No.: US 2020/0182478 A1
(43) Pub. Date: Jun. 11, 2020

(54) Connecting device and gas hob

(71) Applicant: BSH Hausgeräte GmbH, Munich (DE)

(72) Inventors: Luis Acosta Herrero, Maliaño (Cantabria) (ES); Guillaume Hoffbeck, OTTROTT (FR); Alberto Lopez Ortiz, Santander (ES); Luis Antonio Palacios Valdueza, Astillero (ES); Emilio Placer Maruri, Liencres (ES); Roberto Saiz Gonzalez, Villapresente - Cantabria (ES); Thierry Sittler, Lipsheim (FR)

(21) Appl. No.: 16/641,266

(22) PCT Filed: Aug. 24, 2018
(86) PCT No.: PCT/IB2018/056422

§ 371 Date: Feb. 24, 2020

(30) Foreign Application Priority Data
Sep. 4, 2017 (ES) P201731064

(51) Int. Cl. F24C 3/12; F23N 1/00

(52) U.S. Cl. CPC F24C 3/126; F16L 37/025; F23N 1/005

(57) ABSTRACT

A connecting arrangement of a gas pipe of a gas appliance to a gas connection of a gas device of the gas appliance comprising a connecting device to connect the gas pipe to the gas connection. To achieve a safer and more reliable connection between the gas pipe and the gas connection, the connecting device is inserted between the gas pipe and the gas connection. The invention also comprises a gas appliance with such a connecting arrangement and the assembly process of the connecting arrangement.

### PATENT SPECIFICATION

The present invention relates to a connecting arrangement between a gas pipe and a gas device of a gas appliance, to a gas appliance with a connecting arrangement and to an assembly process of a connecting arrangement.

Patent application WO2016075579A1 describes a gas stove with a gas burner, a gas valve and a gas pipe connecting the gas burner to the gas valve. The gas pipe is attached to a gas connection of the gas valve by means of a connecting device.

In view of this background, the object of the present invention is to provide a better, safer and more reliable connecting device.

Accordingly, the object is achieved by a connecting arrangement of a gas pipe of a gas appliance to a gas connection of a gas device of the gas appliance comprising a connecting device to connect the gas pipe to the gas connection, wherein the gas connection has an opening with an opening inner surface having a diameter bigger than the diameter of a pipe outer surface of the gas pipe, which define an opening ring-shaped space between them, the connecting device has an insertion part inserted into the opening tubular space with a meshing section fixed at least axially to the opening inner surface and a gripping section in contact with the pipe outer surface of the gas pipe, thereby limiting the movement of the gas pipe at least axially.

The connecting arrangement of the invention can connect and end of the gas pipe to a gas device of household gas appliances such as cooking appliances or gas heating. The end of the gas pipe is a pipe end having the form of a substantially rectilinear hollow cylinder, the outer surface of the pipe having a substantially circular section. The gas pipe is made of a preferably metallic material, although it could be of a plastic material.

The gas device can be a gas tap or a gas burner having the gas connection. The gas connection is the inlet through which gas can flow into the gas device. The gas connection has an opening in the manner of a substantially constant and rectilinear, cylindrical hollow of a substantially circular section. The connection of the end of the gas pipe to the gas connection is effected by an axial displacement of the pipe end when it is inserted into the opening of the gas connection.

The diameter of the opening of the gas connection is bigger than the diameter of the pipe outer surface of the gas pipe. Therefore, there is an opening tubular space between them, in which the connecting device is mounted. The connecting device has an insertion part inserted into the opening, i.e. fitted into the opening along an insertion depth. The connecting device can also have a stop part at an end remaining outside the gas connection to limit its displacement into the gas connection. The insertion part has a meshing part to fix the connecting device to the opening inner surface in such a manner that its movement is limited at least axially. The insertion part also has a gripping section contacting the pipe outer surface, thereby limiting the axial movement of the pipe, in particular in the opposite direction to the direction of insertion of the gas pipe.

By means of the utilization of the connecting arrangement of the invention, it is possible to dispense with a connecting nut to connect the gas pipe to the gas valve. Since the connecting device is mountable without any tool, it can be mounted in a very quick and easy manner, in particular with no tools. In this manner, the assembly process of the gas pipe at the gas valve can be simplified. Furthermore, since at least a part of the connecting device, in particular the insertion part, remains inside the opening tubular space, the connecting device is protected by the external body of the gas connection. In this manner, the connecting arrangement is more robust and safer.

The gas connection can have an opening inner stop beyond the opening in the direction of insertion of the gas pipe. Besides, the connecting arrangement comprises a sealing device mounted in the opening tubular space between the pipe outer surface and the opening inner surface. The sealing device can be connected to the connecting device at the end of the insertion part inserted into the gas connection. So, during the assembly process of the connecting arrangement, the connecting device and the sealing device can be jointly assembled into the gas connection and subsequently the gas pipe can be inserted into the gas connection passing through both devices, i.e. the connecting and the sealing device, in just one step.

The cylindrical hollow defined by the opening has a constant section and extends into the gas connection from the outer limit of the gas connection up to an opening inner stop. The opening inner stop can be a ring-shaped opening inner stop concentric with the central axis of the opening, having a smaller diameter than the diameter of the opening inner surface. A sealing device, in particular a sealing O-ring gasket, is placed at the opening inner stop and hermetically closes the interior of the gas device and does not let gas escape towards the opening tubular space.

Preferably, the opening inner stop has a substantially ring-shaped form adjusted to the diameter of the gas pipe. More preferably, the opening inner stop extends into the gas device, thereby guiding and aligning the gas pipe.

The gripping section presses the pipe outer surface and limits the movement of the gas pipe at least in the axial direction of extraction of the gas pipe. The gripping section is elastic and forced to a tensed position when the gas pipe passes through it, pressing it when it tends to recover its resting position towards the center of the pipe. In this manner, the end of the gas pipe cannot be easily extracted from the mounting position in the gas connection of the gas device.

For a better attachment of the gas pipe, the pipe outer surface has at least a notch with which at least a flexible flange of the gripping section meshes, thereby limiting the movement of the gas pipe at least in its extraction axial direction. The gripping section has at least a flange, and preferably more than one flexible flange that bend when the gas pipe passes during the assembly and which snap into at least one notch on its surface. The notches can be perimetral grooves on the surface of the pipe. The flange is joined at an end to the meshing section and the other free end extends into the gas connection and the center of the connecting piece. The free end deflects during the insertion of the gas pipe and snaps into the notch on the surface of the gas pipe. In this manner, when an extraction force is exerted upon the gas pipe, the free end opposes the movement of the pipe.

If it is necessary to separate the pipe gas from the gas connection at any time, it is provided that the gripping section is actuable with a tool to loosen the gas pipe. That is, the flexible flanges can be actuated with a tool to loosen the pipe without the need to break the connecting device. In this manner, the connecting device can be removed from the gas device easily and with no damages occurring.

For a simple fixation of the connecting device, it is provided that the meshing section is press-fitted into the opening. The meshing section of the insertion part of the connecting device has a cylindrical meshing outer surface having a diameter slightly bigger than the inner diameter of the opening. In this manner, when the connecting device is mounted into the opening, you need to exert force, so that the connecting device cannot be detached once it is mounted. It is also possible that the meshing outer surface has meshing elements that grab connecting elements arranged on the opening inner surface. With this, a stronger fixation of the connecting device in axial direction can be achieved. This connecting type could fix the connecting device only axially and leave it freed from forces radially around the mounting central axis.

To achieve a low-cost connecting device, it is provided that the meshing section and the gripping section of the insertion part of the connecting device are made in one piece of plastic material. If the connecting device has a stop part, this stop part can also form only one piece of plastic with the rest of the connecting device. In a preferred manner, the connecting device is an injection-moulded plastic component. In this way, a high number of pieces of the connecting device can be manufactured in an economical manner. Alternatively, the connecting device can be made of a metal material. Or a part of the connecting device can be made of plastic, e.g. the stop part and the meshing section, while the gripping section can be made of a flexible metal sheet fixed in a positive-fitting manner to the meshing section.

In an embodiment of the invention, the connecting device of the connecting arrangement comprises an insertion part having a meshing section and a sealing device. The sealing device is at least an O-ring surrounding and encompassing the pipe outer surface. The sealing device can be arranged on an inner face of the insertion part and/or on an end of this. The meshing section is press-fitted onto the opening inner surface having a sealing function. The connecting device can comprise also a stop part to limit its insertion into the opening of the gas connection. In this embodiment, the connecting device is made in one piece of a gum, rubber or silicone material, or the like.

A second aspect of the invention relates to a gas appliance with a gas device and a gas pipe connected to one another by means of a connecting arrangement as described above. The application of this type of connecting arrangements in gas appliances simplifies their assembly, particularly in household gas appliances such as cooking appliances or gas boilers. The gas cooking appliance can be a gas stove, a gas oven or a gas hob.

A third aspect of the invention relates to an assembly process of a connecting arrangement of the invention, wherein, in a first step, the sealing device is inserted into the opening of the gas connection, the connecting device is subsequently inserted into the opening and, finally, the gas pipe is inserted through the gripping section of the connecting device.

The connecting device and/or the gas hob are now described in greater detail by means of preferred embodiments with reference to the attached figures.

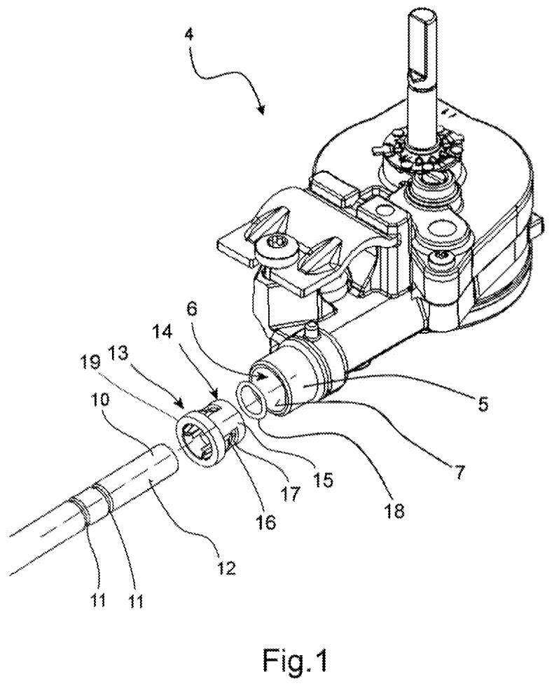

FIG. 1 shows a perspective exploded view of an embodiment of the connecting arrangement of a gas pipe to a gas device;

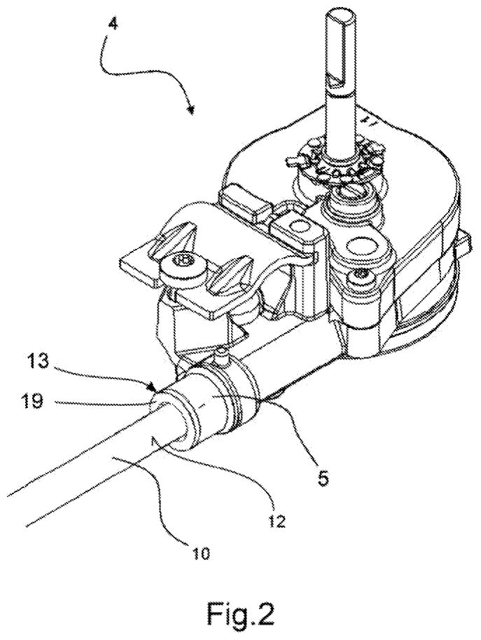

FIG. 2 shows the perspective view of the embodiment of the connecting arrangement according to FIG. 1 having its elements assembled;

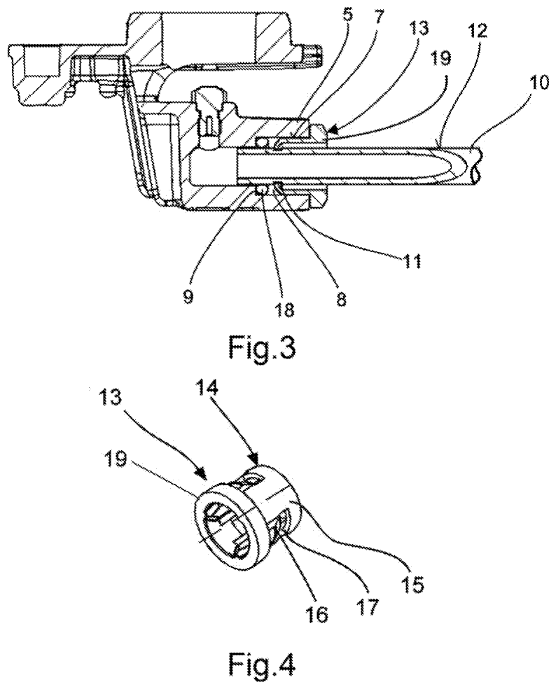

FIG. 3 shows a section view of the connecting arrangement of FIGS. 1 and 2;

FIG. 4 shows a perspective view of the connecting device for the connecting arrangement of FIGS. 1 to 3;

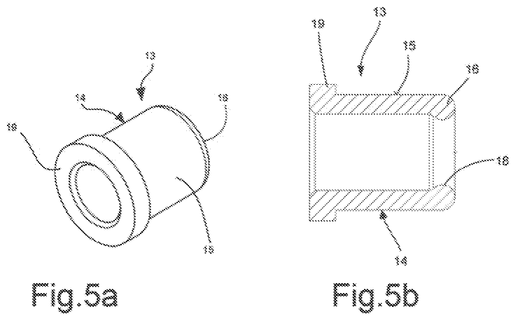

FIG. 5a shows a perspective view of another connecting device for a connecting arrangement of the invention, and

FIG. 5b shows a section view of the connecting device of FIG. 5a.

In the figures, the same elements or having the same function are provided with the same reference numerals, unless indicated otherwise.

FIG. 1 shows schematically a perspective exploded view of a connecting arrangement of a gas pipe 10 to a gas device 4. The gas device 4 of this figure is a gas valve 4 of a gas hob. The gas valve 4 has a housing and a drive shaft projecting beyond the housing. The housing has a gas connection 5 with an opening 6 having a cylindrical opening inner surface 7.

The end of the gas pipe 10 is connectable to the gas connection 5. In this figure, the end of the gas pipe 10 is shown facing the opening 6. The end of the gas pipe 10 is preferably rectilinear as well as the opening 6 of the gas connection 5. A curved configuration would be possible but less practical for the assembly. The gas pipe 10 has a pipe outer surface 12 having notches 11 in an area close to its end.

A sealing device 18 in the form of an O-ring of a material such as gum, rubber, silicone, or the like, is facing the opening 6 of the gas connection 5.

The connecting device 13 is arranged between the sealing device 18 and the gas pipe 10. In this embodiment, the connecting device 13 is made in one plastic piece and has an insertion part 14 and a stop part 19. The insertion part 14 has a meshing section 15 and a gripping section 16 with flanges 17.

FIG. 2 shows the connecting arrangement of FIG. 1 with all its elements assembled. In this manner, the connecting device 13 is inserted into the gas connection 5 of the gas device 4, of which connecting device 13 only its stop part 19 is shown, through which the gas pipe 10 is inserted with its pipe surface 12 guided into the gas connection 5.

FIG. 3 shows a section of the connecting arrangement described in the preceding figures, wherein in this case the gas device 4 is a gas burner with a gas connection 5. The gas device 4 with a gas connection 5 having an opening 6 is shown. The opening 6 has a cylindrical opening inner surface 7 with an opening inner stop 9 made as a diametrical narrowing of the opening 6. The end of the gas pipe 10 having a circular section is inserted into the gas connection 5 through the opening 6 up to a depth beyond the opening inner stop 9. There is an opening tubular space 8 between the pipe outer surface 12 and the opening inner surface 7, into which the connecting device 13 is fitted. The connecting device 13 has a stop part 19 and an insertion part 14 inserted into the opening tubular space 8. The insertion part 14 has a meshing section 15 press-fitted or fitted in a positive-fitting manner onto the opening inner surface 7. The insertion part 14 has a gripping section 16 with flanges 17 protruding from the inner wall of the insertion part 14 and which fit into a notch 11 of the perimeter of the gas pipe 10.

A sealing device 18 in the form of an O-ring gasket is arranged in the opening tubular space 8 at the opening inner stop 9. This sealing device 18 fills the space between the opening inner surface 7 and the pipe outer surface 12. In the demounted state, the sealing device 18 or O-ring gasket has an inner diameter smaller than the outer diameter of the gas pipe 10 and an outer diameter similar to the diameter of the opening 6, particularly in the area with the opening inner stop 9. During the assembly of the connecting arrangement, the gasket is inserted into the opening 6 and subsequently the pipe 10 is inserted through it. Therefore, the gasket expands radially and is pushed against the opening inner surface 7, being pressed and closing the opening tubular space 8 to the flow-through of liquids and in particular gases.

FIG. 4 shows a connecting device 13 for the connecting arrangement of FIGS. 1 and 2. The connecting device 13 has a stop part 19 and an insertion part 14. The outer surface of the insertion part 14 is a meshing section 15 to fit onto the opening inner surface 7. The insertion part 14 has three flanges 17 formed as elements comprised by the gripping section 16 to mesh with the notch 11 of the gas pipe 10. In this embodiment, the connecting device 13 is made in one plastic piece. In other possible embodiments not shown in the figures, the flanges 17 of the gripping section 16 can be made as a metal ring arranged inside the insertion part 14. In any case, the flanges 17 are elastic to let the pipe 10 extend through them and them grip it.

FIG. 5a shows another embodiment of the connecting device 13 in a perspective view. In this case, the connecting device 13 is made in one elastic piece of a gum, rubber, or silicone material, or the like and has a stop part 19 and an insertion part 14. The insertion part 14 has a meshing section 15 made as an outer surface having a diameter slightly bigger than the opening inner surface 7 of the opening 6. In this manner, it can be press-fitted into the opening 6.

FIG. 5b shows a cross-section through the central axis of the connecting device 13 of FIG. 5a. The stop part 19 and the insertion part 14 can be seen. The insertion part 14 has a meshing section 15 made as a surface having an outer diameter bigger than the inner diameter of the opening 6, fitting into the opening 6 in a positive-fitting manner. The gripping section 16 at the end of the insertion part 14 is shown. In this case, the gripping section 16 integrates the sealing device 18 in the manner of a radially closed lip extending towards the center of the connecting device 13 in such a manner that, since it is an elastic element, it lets the gas pipe 10 pass during the assembly and presses it once mounted. This pressure also provides it with the sealing function, since the sealing device 18 closes the opening tubular space 8 when it is deformed.

### REFERENCE NUMERALS

4 Gas device
5 Gas connection
6 Opening
7 Opening inner surface
8 Opening tubular space
9 Opening inner stop
10 Gas pipe
11 Notch
12 Pipe outer surface
13 Connecting device
14 Insertion part
15 Meshing section
16 Gripping section
17 Flange
18 Sealing device
19 Stop part

1-15. (canceled)

16. A connecting arrangement of a gas pipe of a gas appliance to a gas connection of a gas device of the gas appliance, said connecting arrangement comprising a connecting device configured to connect the gas pipe to the gas connection, said connecting device comprising:
an insertion part including a meshing section insertable in a mounting axial direction through an opening of the gas connection into an opening tubular space defined by an opening inner surface of the gas connection, with the opening inner surface of the gas connection having a diameter which is greater than a diameter of a pipe outer surface of the gas pipe, said meshing section being fixed at least axially to the opening inner surface, and
a gripping section contacting the pipe outer surface of the gas pipe, when the gas pipe is received in the connecting device.

17. The connecting arrangement of claim 16, further comprising an opening inner stop formed internally in the gas connection beyond the opening in a direction of insertion of the gas pipe, said opening inner stop having a diameter which is smaller than the diameter of the opening inner surface.

18. The connecting arrangement of claim 16, further comprising a sealing device mounted in the opening tubular space between the pipe outer surface and the opening inner surface.

19. The connecting arrangement of claim 16, wherein the gripping section presses the pipe outer surface and limits a movement of the gas pipe at least in an axial direction of extraction of the gas pipe.

20. The connecting arrangement of claim 16, wherein the gripping section includes a flexible flange for engagement in a notch of the pipe outer surface, thereby limiting a movement of the gas pipe at least in an axial direction of extraction.

21. The connecting arrangement of claim 16, wherein the connecting device is actuable with a tool to loosen the gas pipe.

22. The connecting arrangement of claim 16, wherein the insertion part and the gripping section of the connecting device are made in one piece of plastic material.

23. The connecting arrangement of claim 18, wherein the sealing device is made in one piece with the connecting device.

24. The connecting arrangement of claim 23, wherein the sealing device forms part of the gripping section.

25. The connecting arrangement of claim 16, wherein the connecting device is made of an elastic material.

26. The connecting arrangement of claim 25, wherein the elastic material is rubber or silicone.

27. The connecting arrangement of claim 16, wherein the meshing section is press-fitted into the opening.

28. A gas appliance, comprising
a gas pipe having a pipe outer surface;
a gas device including a gas connection having an opening with an opening inner surface which is defined by a diameter greater than a diameter of the pipe outer surface of the gas pipe to thereby define an opening tubular space; and
a connecting arrangement comprising a connecting device configured to connect the gas device to the gas pipe, said connecting device comprising an insertion part including a meshing section insertable in a mounting axial direction through the opening of the gas connection into the opening tubular space, said meshing section being fixed at least axially to the opening inner surface, and a gripping section contacting the pipe outer surface of the gas pipe, when the gas pipe is received in the connecting device.

29. The gas appliance of claim 28, wherein the gas device is a gas tap and/or a gas burner.

30. The gas appliance of claim 28, wherein the gas connection includes an opening inner stop beyond the opening in a direction of insertion of the gas pipe, said opening inner stop having a diameter which is smaller than the diameter of the opening inner surface.

31. The gas appliance of claim 28, wherein the pipe outer surface of the gas pipe has a notch, said gripping section including a flexible flange for engagement in the notch of the pipe outer surface, thereby limiting a movement of the gas pipe at least in an axial direction of extraction.

32. The gas appliance of claim 28, constructed in the form of a gas cooking appliance such as a gas oven or a gas hob.

33. An assembly process for connecting a gas pipe of a gas appliance to a gas connection of a gas device of the gas appliance, said process comprising:
inserting a sealing device into an opening of the gas connection;
inserting a connecting device into the opening of the gas connection; and
inserting the gas pipe into a gripping section of the connecting device.

34. The assembly process of claim 33, wherein the sealing device is mounted in an opening tubular space between a pipe outer surface of the gas pipe and an opening inner surface of the gas connection.

35. The assembly process of claim 34, wherein the gripping section presses the pipe outer surface and limits a movement of the gas pipe at least in an axial direction of extraction of the gas pipe.

36. The assembly process of claim 33, further comprising engaging the gripping section in a notch of an outer surface of the gas pipe to limit a movement of the gas pipe at least in an axial direction of extraction.

37. The assembly process of claim 33, wherein the connecting device is press-fitted into the opening.
